(19) United States
(12) Patent Application Publication
(10) Pub. No.: US 2026/0187349 A1
(43) Pub. Date: Jul. 2, 2026

(54) DOCUMENT GENERATION APPARATUS, DOCUMENT GENERATION METHOD, AND RECORDING MEDIUM

(71) Applicant: NEC Corporation, Tokyo (JP)

(72) Inventor: Yoshikazu WATANABE, Tokyo (JP)

(73) Assignee: NEC Corporation, Tokyo (JP)

(21) Appl. No.: 19/401,486

(22) Filed: Nov. 26, 2025

(30) Foreign Application Priority Data
Dec. 27, 2024 (JP) 2024-231876

(51) Int. Cl. G06F 40/166; G06F 16/34; G06F 16/35

(52) U.S. Cl. CPC G06F 40/166; G06F 16/345; G06F 16/35

(57) ABSTRACT

A document generation apparatus includes an extraction unit, a classification unit, and a generation unit. The extraction unit extracts an initial query that is an initially input query in a query group and a desired answer that is an answer desired by a user from data in which an input series of query groups is associated with an answer group to the query group generated by referring to an additional document. The classification unit classifies the additional document used to generate the desired answer based on presence or absence of usefulness in generation of the desired answer. The generation unit generates a new additional document based on a document group classified into useful documents.

This application is based upon and claims the benefit of priority from Japanese Patent Application No. 2024-231876, filed on Dec. 27, 2024, the disclosure of which is incorporated herein in its entirety by reference.

### TECHNICAL FIELD

The present disclosure relates to a document generation apparatus and the like.

### BACKGROUND ART

It has been practiced to provide answers generated using a language model in response to inquiries from users. The dialog management apparatus of JP 2023-176054 A generates an answer to an inquiry with reference to documents stored in a storage. The dialog management apparatus of JP 2023-176054 A generates reference documents based on the history of inquiries and answers.

### SUMMARY

A document generation apparatus according to an aspect of the present disclosure includes an extraction unit that extracts an initial query that is an initially input query in a query group and a desired answer that is an answer requested by a user from data in which an input series of query groups is associated with an answer group for the query group generated by referring to an additional document that is a document referred to at a time of generating the answer, a classification unit that classifies the additional document used to generate the desired answer based on presence or absence of usefulness in generation of the desired answer, and a generation unit that generates a new additional document based on a document group classified into useful documents.

A document generation method according to an aspect of the present disclosure includes extracting an initial query that is an initially input query in a query group and a desired answer that is an answer requested by a user from data in which an input series of query groups is associated with an answer group for the query group generated by referring to an additional document that is a document referred to at a time of generating the answer, classifying the additional document used to generate the desired answer based on presence or absence of usefulness in generation of the desired answer, and generating a new additional document based on a document group classified into useful documents.

A non-transitory recording medium according to an aspect of the present disclosure records a program for causing a computer to execute processing of extracting an initial query that is an initially input query in a query group and a desired answer that is an answer requested by a user from data in which an input series of query groups is associated with an answer group for the query group generated by referring to an additional document that is a document referred to at a time of generating the answer, processing of classifying the additional document used to generate the desired answer based on presence or absence of usefulness in generation of the desired answer, and processing of generating a new additional document based on a document group classified into useful documents.

According to the present disclosure, a document suitable for a reference document can be easily generated.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of an information processing system according to an example embodiment of the present disclosure;

FIG. 2 is a diagram illustrating an example of a configuration of a document generation apparatus according to an example embodiment of the present disclosure;

FIG. 3 is a diagram illustrating an example of classification results of useful documents according to an example embodiment of the present disclosure;

FIG. 4 is a diagram schematically illustrating an example of processing of generating an additional document according to an example embodiment of the present disclosure;

FIG. 5 is a diagram illustrating an example of a display screen for selecting a document to be used for generating an additional document according to an example embodiment of the present disclosure;

FIG. 6 is a diagram illustrating an example of a configuration of a chat processing apparatus according to an example embodiment of the present disclosure;

FIG. 7 is a diagram illustrating an example of an operation flow of a document generation apparatus according to an example embodiment of the present disclosure;

FIG. 8 is a diagram illustrating an example of an operation flow of a chat processing apparatus according to an example embodiment of the present disclosure; and

FIG. 9 is a diagram illustrating an example of a hardware configuration according to an example embodiment of the present disclosure.

### EXAMPLE EMBODIMENT

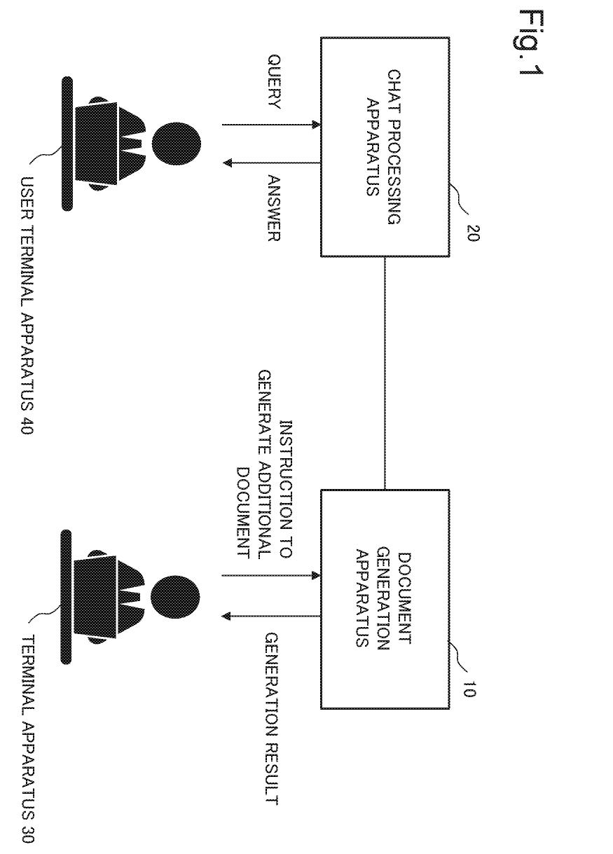

Example embodiments of the present disclosure will be described in detail with reference to the drawings. FIG. 1 is a diagram illustrating an example of a configuration of an information processing system. The information processing system includes, for example, a document generation apparatus 10, a chat processing apparatus 20, a terminal apparatus 30, and a user terminal apparatus 40. The document generation apparatus 10 is connected to the chat processing apparatus 20 via a network, for example. The document generation apparatus 10 is connected to the terminal apparatus 30 via, for example, a network. The chat processing apparatus 20 is connected to the user terminal apparatus 40 via a network, for example. The chat processing apparatus 20, the terminal apparatus 30, and the user terminal apparatus 40 may be plural. The numbers of the chat processing apparatuses 20, the terminal apparatuses 30, and the user terminal apparatuses 40 can be set as appropriate.

For example, the information processing system generates an answer to a query input by the user using a language model. In the information processing system, the input of the query by the user and the output of the answer to the query are performed in a chat format, for example. As the language model, for example, a large language model is used. A specific example of the large language model will be described later. The information processing system inputs the additional document to the language model together with the query. Then, the language model generates an answer to the query with reference to, for example, the additional document. The additional document is, for example, a reference document that the language model refers to when generating an answer to the query. That is, the language model generates answers to the query using reference documents. A method of generating an answer with reference to an additional document in a large language model is also called retrieval-augmented generation (RAG), for example.

For example, the information processing system extracts an additional document that matches the query from a database of additional documents. Then, the information processing system generates an answer to the query, for example, using the query and the additional document as inputs of the language model. The information processing system stores the query and the additional document used for input to the language model in association with each other as history data for each session, for example. The session refers to, for example, input of a series of queries for one theme and processing of generating an answer to the query. For example, the information processing system generates a new additional document by using the additional document useful for generating the desired answer to the query. The desired answer is, for example, an answer suitable for the user as an answer to the query. That is, the desired answer is an answer including information required by the user, and is an answer that is likely to end the session in a case where the answer is obtained. For example, the information processing system stores the generated additional document as a new additional document in the database of the additional document. By storing the additional document generated in this manner in the database as a new additional document, for example, in a case where a similar query is input again, the information processing system can generate an answer with reference to the new additional document. By generating the answer with reference to the new additional document, the information processing system can suppress, for example, the number of repetitions of the input of the query, the generation of the answer, and the output of the answer until the user obtains the desired answer.

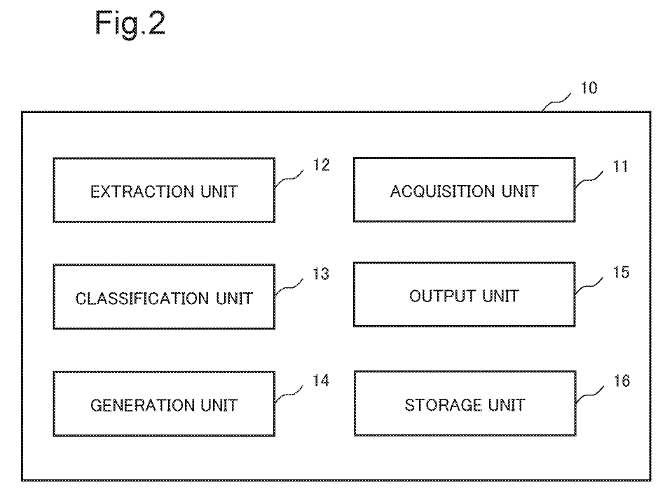

Here, a specific example of the configuration of the document generation apparatus 10 will be described. FIG. 2 is a diagram illustrating an example of a configuration of the document generation apparatus 10. The document generation apparatus 10 includes an extraction unit 12, a classification unit 13, and a generation unit 14 as a basic configuration. The document generation apparatus 10 further includes, for example, an acquisition unit 11, an output unit 15, and a storage unit 16.

The acquisition unit 11 acquires, for example, a series of input query groups and answer groups for the query groups generated with reference to the additional document. For example, the acquisition unit 11 acquires, from a history data storage unit 25 of the chat processing apparatus 20, a series of query groups input by the user and answer groups to the query groups generated with reference to the additional document. The user is, for example, a person who obtains an answer to the query using the chat processing apparatus 20. The user may also include a virtual entity. The virtual entity is, for example, an artificial intelligence (AI) agent. The virtual entity is not limited to the above.

For example, the acquisition unit 11 acquires a query group and an answer group to the query group for each session. For example, the acquisition unit 11 acquires a query group and an answer group to the query group for each session for a plurality of sessions. The session refers to, for example, input of a related query performed from the first input of the query by the user to acquisition of a desired answer and processing of generating an answer to the query. In other words, the session refers to a series of processing performed to further input a query to the answer to approach the answer that is a desired answer. In a case where the user starts over from the input of the first query, for example, a new session is handled from the query input next. The session to be acquired among the plurality of sessions may be selected by, for example, a person in charge. The person in charge is, for example, a person who performs work related to processing of generating an additional document.

The acquisition unit 11 may acquire the attribute of the user associated with the query group and the answer group to the query group for each session. The attribute of the user is, for example, an attribute that affects the level required for the answer. For example, the attribute of the user is information in one or more items among the expertise, the proficiency level, and the position of the user. For example, in a case where a user who is an administrator of a computer obtains an answer regarding a problem in the operation of the computer, the user may need a handling method associated with detailed settings of the computer. On the other hand, for example, in a case where a general user of a computer obtains an answer regarding a problem in the operation of the computer, the user may need a handling method that can solve the problem without requiring specialized knowledge. In such a case, for example, by associating an attribute related to the expertise of the user with the additional document, it is possible to obtain a more suitable answer for the user.

The attribute of the user may be, for example, an attribute that affects the content of the requested answer. In this case, the attribute of the user is, for example, information in one or more items of the user's affiliation, gender, age, place of residence, family structure, and occupation. The attribute of the user is not limited to the above. For example, in a case where the user obtains information regarding the administrative service, the required answer may be different because the administrative service provided differs depending on the age and place of residence of the user. In such a case, for example, it is possible to obtain a more suitable answer for the user by associating the attributes related to the age and place of residence of the user with the additional document.

In a case where the initial query is selected by the person in charge, the acquisition unit 11 acquires, for example, a selection result of the initial query. The acquisition unit 11 acquires, for example, a selection result of the initial query from the terminal apparatus 30. In a case where the desired answer is selected by the person in charge, the acquisition unit 11 acquires, for example, a selection result of the desired answer. The acquisition unit 11 acquires, for example, a selection result of the desired answer from the terminal apparatus 30.

In a case where a new additional document is generated by using the selected additional document among the additional documents used for generating the answer, the acquisition unit 11 acquires, for example, a selection result of the additional document used for generating the new additional document. The acquisition unit 11 acquires, for example, a selection result of an additional document to be used for generating a new additional document from the terminal apparatus 30. The additional document used to generate the answer is, for example, an additional document input to a language model that generates an answer for processing of generating an answer to the query. That is, the additional document used to generate the answer may include an additional document that is input to the language model that generates the answer to the query but is not used by the language model to generate the answer. In a case where the additional document is a fragment of a document, the acquisition unit 11 may acquire a peripheral fragment of the document in addition to the additional document. Being a fragment of a document means, for example, that the additional document is a part of the document. In a case where the additional document is a fragment of the document, the acquisition unit 11 acquires, for example, a fragment described at a position close to the additional document in the document together with the additional document.

The extraction unit 12 extracts an initial query that is an initially input query in the query group and a desired answer that is an answer desired by the user from data in which a series of query groups input by the user and an answer group for the query group generated by referring to the additional document are associated with each other. A series of query groups input by the user is, for example, a query for each session input by the user to the chat processing apparatus 20. For example, the extraction unit 12 extracts an initial query and a desired answer from data in which a query group and an answer group included in one session are associated with each other.

For example, the extraction unit 12 extracts the first query of the session among the queries included in the query group as the initial query. The extraction unit 12 may extract a query in a predetermined order during the session among the queries included in the query group as the initial query. The predetermined order for setting the extraction targets is set to be, for example, the order in which there is a high possibility that a query suitable for the initial query is input. For example, in a case where a typical sentence is input to the first query and specific contents are input after the second query, the predetermined order is set to the second. The criterion of how to set the predetermined order is not limited to the above.

The extraction unit 12 may exclude a query in a predetermined order in the session from the extraction target of the initial query. For example, the extraction unit 12 excludes a query after a predetermined order from an extraction target of the initial query. The predetermined order for excluding the query from the extraction target is set, for example, so that a query unsuitable as an initial query can be excluded from the extraction target. In a case where the content of the query included in the query group has changed in the middle, the extraction unit 12 may exclude the query group in which the content of the query has changed in the middle and the answer group for the query group from the extraction target. The change in the content of the query means, for example, a change in the theme targeted by the query. For example, the change in the content of the query means that, in a case where the query in the initial stage is a question related to the method of settling the domestic business trip travel expense, the query is changed from the middle to a question related to the transfer system.

The extraction unit 12 may extract a query selected by the user of the chat processing apparatus 20 as an initial query. For example, the extraction unit 12 extracts the initial query based on a selection result of the initial query by the user on the initial query selection screen. The selection of the initial query may be performed on a display screen of a chat for inputting a query and outputting an answer.

The extraction unit 12 may extract the query selected by the person in charge as the initial query. For example, the extraction unit 12 extracts a query selected from queries included in the query group as an initial query. For example, the extraction unit 12 extracts a query selected on a display screen displaying a list of queries included in a query group as an initial query. The person in charge is, for example, a person who performs work related to generation of a new additional document using the document generation apparatus 10. The user and the person in charge may be the same person. The person in charge may also include a virtual entity. That is, in a case where the selection of the initial query is performed by the user or the person in charge, the selection of the initial query may be performed by a virtual entity. The virtual entity is, for example, an AI agent. The virtual entity is not limited to the above.

For example, the extraction unit 12 extracts the last answer in the session among the answers included in the answer group as the desired answer. The extraction unit 12 may extract answers in a predetermined order from the end of the session among the answers included in the answer group as the desired answer. For example, in a case where the last answer of the session is a typical sentence not related to the initial query, the extraction unit 12 selects the second answer from the end of the session as the desired answer. The predetermined order from the end of the session is set such that, for example, an answer not related to the answer desired by the user is not extracted as the desired answer. That is, the predetermined order from the end of the session is set such that, for example, the extracted answer is the answer desired by the user. The extraction unit 12 may exclude answers in a predetermined order within a session from targets for extracting desired answers. For example, the extraction unit 12 excludes answers before a predetermined order from desired answer extraction targets. The predetermined order for excluding the answer from the extraction target is set so that, for example, an answer unsuitable as the desired answer can be excluded from the extraction target.

The extraction unit 12 may extract an answer selected by the user of the chat processing apparatus 20 as the desired answer. For example, the extraction unit 12 extracts the desired answer based on a selection result of the desired answer by the user on the selection screen of the desired answer. The selection of the desired answer may be performed on a display screen of a chat for inputting a query and outputting an answer. For example, the extraction unit 12 may extract an answer with a high evaluation checked on the chat display screen as the desired answer.

The extraction unit 12 may extract an answer selected by the person in charge as the desired answer. For example, the extraction unit 12 extracts an answer selected from among the answers included in the answer group as the desired answer. For example, the extraction unit 12 extracts an answer selected on a display screen displaying a list of answers included in the answer group as the desired answer.

The extraction unit 12 may extract the initial query and the desired answer for each session group. The session group is, for example, a group of sessions similar to each other. The extraction unit 12 groups the sessions based on the similarity of at least one of the query, the answer, or the additional document. The extraction unit 12 groups the sessions based on similarity of at least one of the query, the answer, or the additional document by using, for example, a language model.

For example, Word2vec is used as a language model for grouping sessions. As a language model for grouping sessions, Generative Pre-trained Transformer-2 (GPT-2), GPT-3, GPT-3.5, GPT-4, or GPT-4o may be used. As a language model for grouping sessions, Claude3, Claude3.5, Text-to-Text Transfer Transformer (T5), Bidirectional Encoder Representations from Transformers (BERT), Robustly optimized BERT approach (RoBERTa), or Efficiently Learning an Encoder that Classifies Token Replacements Accurately (ELECTRA) may be used. The language model for grouping the sessions is not limited to the above.

In a case where the initial query and the desired answer are extracted for each session group, the extraction unit 12 may set a session group in which the number of included sessions is equal to or more than a criterion as an extraction target of the initial query and the desired answer. The criterion of the number of sessions is set to, for example, a number that can suppress the influence of a specific session.

For example, the extraction unit 12 extracts a query having the highest similarity with another query among queries included in the session group as an initial query. For example, the extraction unit 12 calculates similarity with another query for each query included in the session group. Then, the extraction unit 12 extracts, for example, a query having the highest average value of similarity to other queries as an initial query.

The extraction unit 12 converts each query included in the session group into a feature vector using, for example, a language model. For example, Word2vec is used as the language model. The language model is not limited to the above. For example, the extraction unit 12 calculates similarity between the feature vectors converted from the queries. Then, the extraction unit 12 sets, for example, the similarity between queries as the similarity between feature vectors related to the queries. For example, a cosine similarity or a Euclidean distance is used as the similarity between the feature vectors. The similarity between the feature vectors may be other than the above.

The extraction unit 12 may generate the initial query by using queries having an average value of similarity to other queries included in the session group from the top to a predetermined rank. For example, the extraction unit 12 generates a new query by combining a plurality of queries up to a predetermined rank using the language model. For example, Word2vec can be used as a language model for generating a new query. The language model for generating the new query may be a large language model. The language model for generating the new query is not limited to the above. The predetermined rank is set to be, for example, the number of features suitable as the initial query remaining in the combined query. Remaining features means, for example, that a session group can be distinguished from other different queries. Then, for example, the extraction unit 12 handles the generated new query as an initial query. The extraction unit 12 may generate the initial query using a plurality of queries in which the average value of the similarity to other queries is equal to or more than a predetermined criterion. For example, the extraction unit 12 generates an initial query by combining a plurality of queries in which the average value of the similarity is equal to or more than a predetermined criterion, using the language model. The predetermined criterion is set, for example, such that the feature of the session group remains in the query after the composition.

For example, the extraction unit 12 extracts an answer having the highest similarity with other answers among the answers included in the session group as the desired answer. For example, the extraction unit 12 calculates similarity between each answer included in the session group and another answer. Then, the extraction unit 12 extracts, for example, an answer having the highest average value of similarity to other answers as the desired answer.

The extraction unit 12 converts each answer included in the session group into a feature vector using, for example, a language model. For example, Word2vec is used as the language model to convert the answer into the feature vector. The language model to convert the answer into the feature vector is not limited to the above. For example, the extraction unit 12 calculates similarity between the feature vectors converted from the answers. Then, the extraction unit 12 sets, for example, the similarity between answers as the similarity between feature vectors related to the answers. For example, a cosine similarity or a Euclidean distance is used as the similarity between the feature vectors. The similarity between the feature vectors may be other than the above.

The extraction unit 12 may generate the desired answer by using answers having an average value of similarity to other answers included in the session group from the top to a predetermined rank. For example, the extraction unit 12 generates a new answer by combining a plurality of answers up to a predetermined rank using a language model. For example, Word2vec can be used as a language model for generating a new answer. A large language model may be used as a language model for generating a new answer. The language model for generating a new answer is not limited to the above. The predetermined rank is set to be, for example, the number of features suitable as the desired answer remaining in the combined answer. Remaining features means, for example, being distinguishable from other answers belonging to different session groups. Then, for example, the extraction unit 12 handles the generated new answer as the desired answer. The extraction unit 12 may generate the desired answer using a plurality of answers in which an average value of similarity to other answers is equal to or more than a predetermined criterion. For example, the extraction unit 12 generates a desired answer by combining a plurality of answers in which the average value of the similarity is equal to or more than a predetermined criterion using the language model. The predetermined criterion is set, for example, such that the features of the session group remain in the combined answer.

The classification unit 13 classifies the additional documents used for generating the desired answer based on the presence or absence of usefulness in generating the desired answer. The classification unit 13 classifies, for example, whether the additional document used to generate the answer is a document useful for generating the desired answer. The classification unit 13 uses, for example, a language model to classify whether the additional document referred to in generating the desired answer is a document useful for generating the desired answer. For example, the classification unit 13 classifies whether the additional document referred to in generating the desired answer is a document useful for generating the desired answer, using an instruction to classify whether the document is a document useful for generating the desired answer, an initial query, the desired answer, and the referred additional document as inputs of a language model. That is, the classification unit 13 classifies whether the additional document referred to in generating the desired answer is a document useful for generating the desired answer by using, as input to the language model, a prompt including an instruction to classify whether the document is useful for generating the desired answer, an initial query, the desired answer, and the referred additional document.

For example, a large language model is used as the language model used for classification of the additional document. As a language model used for classification of the additional document, for example, GPT-2, GPT-3, GPT-3.5, GPT-4, or GPT-4o may be used. Claude3, Claude3.5, T5, BERT, RoBERTa, or ELECTRA may be used as a language model used for classification of additional documents. The language model used for classification of the additional document is not limited to the above.

The classification unit 13 may calculate the usefulness of the additional document used to generate the desired answer. The classification unit 13 calculates, for example, the usefulness of the additional document used to generate the desired answer using the language model. Then, the classification unit 13 classifies the additional document whose usefulness is equal to or more than the criterion into useful additional documents. The criterion of the usefulness for classifying the additional documents is set such that, for example, in a case where the usefulness satisfies the criterion, the additional documents become documents suitable for generating an answer to the query. The classification unit 13 may classify each of the referred additional documents into groups based on the stages of the usefulness set in a plurality of stages. For example, the classification unit 13 classifies each of the referenced additional documents into groups based on the stages of usefulness set in three stages. The stage of usefulness may be four or more stages. The language model may perform calculation of the usefulness and classification processing based on the usefulness. In this case, the language model may output the usefulness of each additional document together with the classification result of the usefulness.

The classification unit 13 may classify the additional document by using a language model that operates in an information processing apparatus outside the information processing system. The classification unit 13 outputs, for example, a prompt including an instruction to classify whether the document is useful for generating the desired answer, an initial query, the desired answer, and the referred additional document to the information processing apparatus in which the large language model operates. Then, the classification unit 13 acquires, for example, a classification result of the additional document based on the usefulness in generating the desired answer from the information processing apparatus to which the prompt is output.

The classification unit 13 may classify the additional document by using a language model that operates in the chat processing apparatus 20. The classification unit 13 outputs, for example, a prompt including an instruction to classify whether the document is useful for generating the desired answer, an initial query, the desired answer, and the referred additional document to the chat processing apparatus 20. Then, the classification unit 13 acquires, for example, a classification result of the additional document based on the usefulness in generating the desired answer from the chat processing apparatus 20.

The classification unit 13 may classify the additional document at a timing based on the load state of the information processing apparatus on which the language model operates. The classification unit 13 classifies the additional document using the language model, for example, at a timing based on a use state of the language model that generates an answer to the query. For example, the classification unit 13 classifies the additional document at a timing based on the load state of the chat processing apparatus 20 on which the language model operates or the information processing apparatus outside the information processing system. The classification unit 13 may classify the additional document in a case where the load state of the information processing apparatus on which the language model operates is equal to or less than the criterion. The criterion of the load state is set, for example, such that the classification processing does not affect other processing. The classification unit 13 may classify the additional document in a predetermined time zone. The predetermined time zone is set to, for example, a time at which the processing capability of the information processing apparatus that performs the classification processing of the additional document has reserve power. In a case where the usage fee is set according to the stage of the processing amount by the language model per unit period, the classification unit 13 may determine the timing of performing the classification processing so that the usage fee does not increase even if the processing is performed, and perform the classification processing. For example, in a case of a contract in which the usage fee increases in a case where the usage of the language model per month exceeds the processing amount P, the classification unit 13 performs processing of classifying the additional document so as not to exceed the processing amount P, for example. The available processing amount in the language model is set, for example, in units of tokens.

The classification unit 13 may classify the additional document at a timing based on a use state of the chat processing apparatus 20 on which the language model operates or an external information processing apparatus. For example, the classification unit 13 may classify the additional document at a timing on condition that the input/output throughput of the language model is below a predetermined threshold as an index. The input/output throughput is, for example, an index indicated by the number of tokens per unit time. For example, the predetermined threshold is set to a value that does not affect other processing even if processing related to the classification of the additional document is performed. The predetermined threshold may be determined by a condition related to a usage contract of the information processing apparatus on which the language model operates.

In a case where the language model that generates the answer to the query outputs the additional document referred to when generating the answer, the classification unit 13 may acquire the additional document referred to by the language model. In this case, for example, the classification unit 13 classifies the additional document referred to by the acquired language model into useful documents.

The generation unit 14 generates an additional document based on the additional document classified as a useful document. The generation unit 14 generates a new additional document by summarizing additional documents classified as useful documents. For example, it is assumed that, among additional document A, additional document B, additional document C, additional document D, and additional document E, additional document A, additional document B, and additional document E are classified as useful documents. In this case, for example, the generation unit 14 generates the additional document N as a new additional document by summarizing the additional document A, the additional document B, and the additional document E.

The generation unit 14 summarizes the additional documents classified as useful documents, for example, using a language model. For example, the generation unit 14 generates a summary of the additional document classified into the useful document as a new additional document by using the additional document classified into the useful document and the instruction of the summary as an input of a language model. The generation unit 14 uses the initial query, the additional documents classified as the useful documents, and the instruction of the summary as an input of a language model, and generates a summary of the additional documents classified as the useful documents as a new additional document.

As the language model, for example, a large language model is used. As a large language model for generating a summary, for example, GPT-2, GPT-3, GPT-3.5, GPT-4, or GPT-4o is used. Claude3, Claude3.5, T5, BERT, RoBERTa, or ELECTRA may be used as a large language model for generating a summary. The large language model used in the processing of classifying the additional document is not limited to the above. The language model used by the generation unit 14 for summarization and the language model used by the classification unit 13 for classification as to whether the document is useful for generating the desired answer may be the same language model, or may be different language models.

The generation unit 14 may summarize the additional document classified as the useful document at a timing based on the use state of the chat processing apparatus 20 on which the language model operates or the external information processing apparatus. For example, the generation unit 14 may summarize the additional document classified as the useful document at a timing on a condition that the input/output throughput of the language model is below a predetermined threshold as an index. The input/output throughput is, for example, an index indicated by the number of tokens per unit time. For example, the predetermined threshold is set to a value that does not affect other processing even if processing related to the summary of the additional document classified as the useful document is performed. The predetermined threshold may be determined by a condition related to a usage contract of the information processing apparatus on which the language model operates.

In a case where the classification unit 13 calculates the usefulness of each of the additional documents, the generation unit 14 may weight each of the additional documents based on the usefulness to generate a summary. The generation unit 14 generates a summary weighted based on the usefulness, for example, by inputting the usefulness to the language model in association with each of the additional documents. In a case where the classification unit 13 classifies the additional document into groups based on the stages of the usefulness set in a plurality of stages, the generation unit 14 may generate a new additional document by summarizing the additional document by performing weighting according to the stage of the usefulness for each group. For example, in a case where the usefulness is set in three stages, the generation unit 14 performs weighting related to each of the three stages to summarize the additional document, and generates a new document. The generation unit 14 may associate the weight calculated from the usefulness of each additional document with each additional document and input the weight to the language model, thereby generating a summary weighted based on the usefulness.

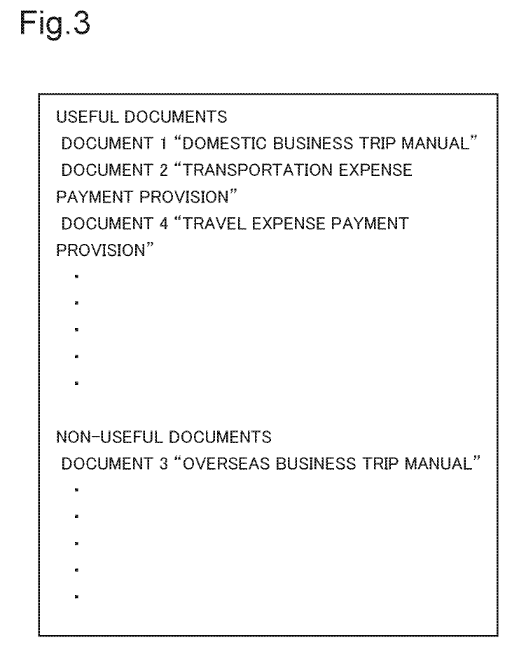

FIG. 3 is an example of a classification result classified based on the presence or absence of usefulness of the additional document. In the example of the classification result of the additional documents in FIG. 3, the additional documents used for inputting the language model are classified into “useful documents” and “non-useful documents”. In the example of the classification result in FIG. 3, for example, Document 1 “Domestic Business Trip Manual”, Document 2 “Transportation Expense Payment Provision”, and Document 4 “Travel Expense Payment Provision” are classified as “useful documents”. In the example of the classification result in FIG. 3, for example, Document 3 “Overseas Business Trip Manual” is classified as “non-useful document”. The generation unit 14 generates a new additional document, for example, using a document classified as “useful document” in the example of the classification result of FIG. 3.

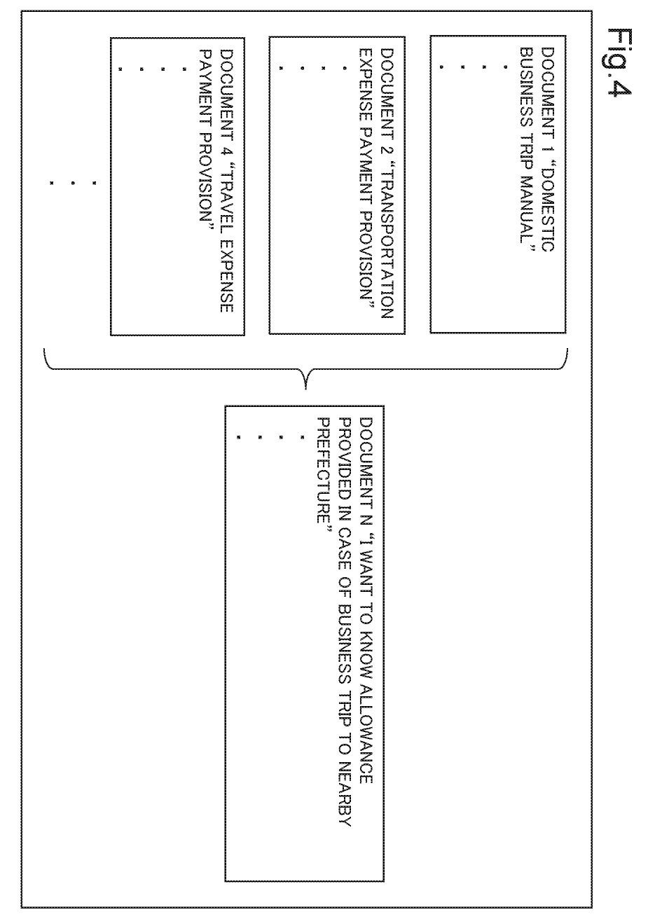

FIG. 4 illustrates an example of processing of generating a new additional document using an additional document classified into useful documents as in the example of FIG. 3. In the example of FIG. 4, the generation unit 14 generates a new document N as a new additional document by summarizing documents classified into useful documents such as Document 1, Document 2, and Document 4. In this way, by generating a new document from the additional documents classified as useful documents, it is possible to generate an additional document more suitable for generating an answer to the query.

The output unit 15 outputs, for example, the new additional document generated by the generation unit 14. The output unit 15 outputs the generated new additional document to a database unit 24 of the chat processing apparatus 20, for example. The output unit 15 may output the generated new additional document in association with the initial query.

The output unit 15 may store the attribute of the user in association with the generated new additional document. The attribute of the user is, for example, an attribute of a person who obtains an answer using the chat processing apparatus 20. The attribute of the user is acquired from the chat processing apparatus 20 together with, for example, data in which a query group used for generating a new additional document and an answer group for the query group are associated with each other. The attribute of the user may be added to the new additional document by a person in charge of generating the additional document. The attribute of the user may be an attribute estimated from the input query. For example, the attribute of the user is estimated by referring to data in a table format in which the query and the attribute of the user are associated with each other. The attribute of the user may be estimated using a deep learning model generated by learning the relationship between the query and the attribute of the user. The attribute of the user may be estimated by inputting, as a prompt, a query for requesting estimation of the attribute of the user to the large language model. The query used for estimating the attribute of the user is not limited to the initial query. The attribute of the user is estimated by the generation unit 14, for example. The estimation of the attribute of the user may be performed by other than the generation unit 14. The estimation of the attribute of the user may be performed in the chat processing apparatus 20, and the acquisition unit 11 may acquire the estimation result of the attribute of the user from the chat processing apparatus 20.

The output unit 15 may output the generated new additional document and the additional document used to generate the new additional document in association with each other. The output unit 15 may emphasize and output a sentence related to a sentence included in the new additional document among sentences included in the additional document used to generate the new additional document.

In a case where the initial query can be selected, the output unit 15 outputs, for example, a display screen for selecting the initial query. The output unit 15 outputs, for example, to the terminal apparatus 30, a display screen for selecting an initial query. The output unit 15 outputs, for example, a display screen displaying the candidates of the initial query and the selection field as a display screen for selecting the initial query.

In a case where the desired answer can be selected, the output unit 15 outputs, for example, a display screen for selecting the desired answer. The output unit 15 outputs, for example, to the terminal apparatus 30, a display screen for selecting a desired answer. The output unit 15 outputs, for example, a display screen displaying a candidate for the desired answer and a selection field as a display screen for selecting the desired answer.

The output unit 15 may output a display screen for selecting an additional document to be used for generating a new additional document from the additional documents used for generating the desired answer. The output unit 15 outputs, for example, to the terminal apparatus 30, a display screen for selecting additional documents to be used for generating a new additional document.

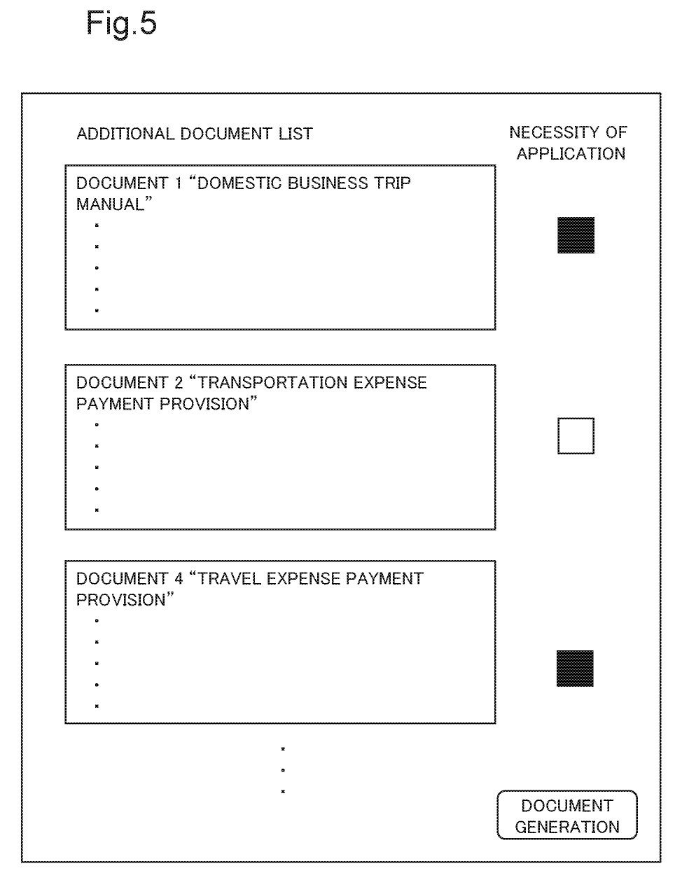

FIG. 5 is an example of a display screen for selecting a document to be used for generating a new additional document. In the example of the display screen of FIG. 5, selection fields of “additional document list” and “necessity of application” and buttons of “document generation” are displayed. In the example of the display screen of FIG. 5, the “additional document list” is, for example, a field for displaying a list of additional documents used as input to the language model. The “necessity of application” selection field is, for example, a field for selecting an additional document to be used for a summary for generating a new additional document. In the example of the display screen of FIG. 5, for example, a black square indicates a state in which an additional document is selected. In the example of the display screen of FIG. 5, for example, a white square indicates a state in which no additional document is selected. In the example of the display screen of FIG. 5, the button of “document generation” is, for example, a button for starting generation of a new additional document using the additional document in the selected state.

The output unit 15 outputs, for example, a display screen for selecting an additional document to be used for generating a new additional document as illustrated in the example of FIG. 5 to the terminal apparatus 30. The acquisition unit 11 acquires, from the terminal apparatus 30, a selection result of an additional document to be used for generation of a new additional document input by an operation of a person in charge on a display screen displayed on a display apparatus of the terminal apparatus 30. Then, the generation unit 14 generates a new additional document by summarizing the additional document selected in the selection result.

The storage unit 16 stores, for example, data related to processing of generating an additional document. The storage unit 16 stores, for example, a series of query groups input by the user and an answer group for the query group generated with reference to the additional document. The storage unit 16 stores, for example, the extracted initial query and the desired answer. The storage unit 16 stores, for example, the generated new additional document. In a case where the initial query can be selected, the storage unit 16 stores, for example, a selection result of the initial query. In a case where the desired answer can be selected, the storage unit 16 stores, for example, a selection result of the desired answer. The storage unit 16 may store a language model used for each processing. The data stored in the storage unit 16 is not limited to the above.

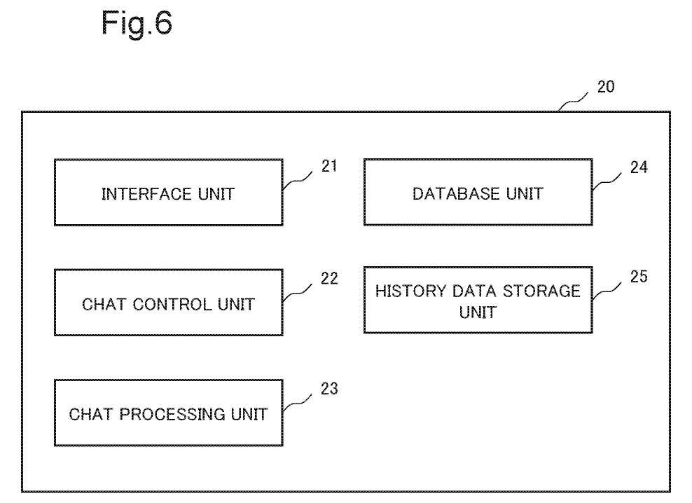

An example of a configuration of the chat processing apparatus 20 will be described. FIG. 6 is a diagram illustrating an example of a configuration of the chat processing apparatus 20. The chat processing apparatus 20 includes, for example, an interface unit 21, a chat control unit 22, a chat processing unit 23, the database unit 24, and the history data storage unit 25.

The interface unit 21 acquires, for example, a query input by a user's operation. The interface unit 21 acquires, for example, a query input by a user's operation from the user terminal apparatus 40. The interface unit 21 outputs, for example, an answer to the query generated in the chat processing unit 23. The interface unit 21 outputs an answer to the query to the user terminal apparatus 40, for example.

The chat control unit 22 acquires a query from the interface unit 21, for example. For example, the chat control unit 22 extracts an additional document that matches the query. Then, the chat control unit 22 outputs, for example, a query and the extracted additional document to the chat processing unit 23.

For example, the chat control unit 22 extracts the additional document based on the similarity between the feature vector converted from the query and the feature vector converted from the additional document. The chat control unit 22 converts the query into a feature vector using, for example, a language model. Then, similarity between the feature vector converted from the query and the feature vector converted from the additional document is calculated. For example, the chat control unit 22 calculates a similarity between the feature vector converted from the query using the Euclidean distance or the cosine similarity and the feature vector converted from the additional document. The index indicating the similarity is not limited to the Euclidean distance and the cosine similarity. For example, Word2vec is used as a language model for converting a query into a feature vector. The language model that converts the query into the feature vector is not limited to the above.

For example, the chat control unit 22 extracts an additional document having a similarity equal to or more than a predetermined criterion as an additional document that matches the query. The chat control unit 22 may extract the additional documents having the similarity from the top to the predetermined rank as the additional documents that match the query. The chat control unit 22 may extract additional documents having a similarity equal to or more than a predetermined criterion and in a predetermined rank from the top as additional documents that match the query. The predetermined criterion and the predetermined rank used for extracting the similarity are set such that the extracted additional document becomes an additional document suitable for the query.

The chat control unit 22 may extract the additional document based on the attribute of the user in addition to the similarity between the query and the additional document. The attribute of the user is, for example, an attribute that affects at least one of the level or the content required for the answer. The chat control unit 22 extracts an additional document matching the query from the additional documents of which the attribute associated with the additional document matches the attribute of the user who has input the query based on the similarity. Matching includes similarity. By using the additional document extracted based on the attribute of the user for generating the answer, an answer more suitable for the user can be generated even for a similar query.

The attribute of the user is stored in association with, for example, identification information of the user. The identification information of the user is, for example, an identification number of the user. The identification information of the user is not limited to the above. The chat control unit 22 may estimate the attribute of the user by using a deep learning model generated by learning the relationship between the query and the attribute of the user. The chat control unit 22 may estimate the attribute of the user by inputting, as a prompt, a query for requesting estimation of the attribute of the user to the large language model. The query used for estimating the attribute of the user is not limited to the initial query.

For example, the chat control unit 22 outputs a query and an additional document to the chat processing unit 23. The chat control unit 22 acquires, for example, an answer to the query from the chat processing unit 23. Then, the chat control unit 22 outputs an answer to the acquired query to the interface unit 21. The chat control unit 22 stores the query, the additional document, and the answer to the query in association with each other in the history data storage unit 25, for example. For example, the chat control unit 22 stores the query, the additional document, and the answer to the query in the history data storage unit 25 in association with each other for each session. The chat control unit 22 may store the query, the additional document, and the answer to the query in association with the order of the query in the session in the history data storage unit 25. The chat control unit 22 may store the query, the additional document, and the answer to the query in association with the order of the query in the session, and store the attribute of the user in association with the query.

The chat processing unit 23 generates, for example, an answer to the query. The chat processing unit 23 generates an answer to the query using, for example, a language model. As the language model, for example, a large language model that generates a document with reference to an additional document is used. For the large language model, for example, GPT-2, GPT-3, GPT-3.5, GPT-4, or GPT-4o is used. Claude3, Claude3.5, T5, BERT, RoBERTa, or ELECTRA may be used as the large language model.

The chat processing unit 23 may generate an answer to the query based on the attribute of the user. For example, the chat processing unit 23 generates an answer based on the attribute of the user by using a prompt including information indicating the attribute of the user for inputting the language model. For example, the chat processing unit 23 generates an answer suitable for a beginner by using a prompt for instructing to generate an answer for a beginner as an input of a language model.

The chat processing unit 23 may classify the additional document by using a language model that operates in an information processing apparatus outside the chat processing apparatus 20. The chat processing unit 23 outputs a query and an additional document to an information processing apparatus in which a large language model operates, for example. Then, the chat processing unit 23 acquires, for example, an answer to the query from the information processing apparatus that is an output destination of the query and the additional document.

The database unit 24 stores, for example, the additional document. For example, the database unit 24 stores the additional document in a vectorized state. For example, in a case where a new additional document is acquired, the database unit 24 vectorizes and stores the newly acquired document. The additional document may be associated with an attribute of the user suitable for generating an answer using the additional document.

The history data storage unit 25 stores, for example, the query, the answer to the query, the query input order, and the additional document in association with each other. The history data storage unit 25 groups and stores, for example, data in which the query, the answer to the query, the query input order, and the additional document are associated for each session.

The terminal apparatus 30 is, for example, an information processing apparatus used by a person in charge who performs processing of generating a new additional document in the information processing system. The terminal apparatus 30 acquires a new additional document from the output unit 15 of the document generation apparatus 10, for example. Then, the terminal apparatus 30 outputs a new additional document to a display apparatus (not illustrated), for example.

In a case where the person in charge selects the initial query, the terminal apparatus 30 acquires, for example, a display screen for selecting the initial query from the output unit 15 of the document generation apparatus 10. Then, the terminal apparatus 30 outputs a display screen for selecting an initial query to a display apparatus (not illustrated), for example. The terminal apparatus 30 acquires, for example, a selection result of the initial query input by the operation of the person in charge on the display screen for selecting the initial query. Then, for example, the terminal apparatus 30 outputs a selection result of the initial query to the acquisition unit 11 of the document generation apparatus 10.

In a case where the person in charge selects the desired answer, the terminal apparatus 30 acquires, for example, a display screen for selecting the desired answer from the output unit 15 of the document generation apparatus 10. Then, the terminal apparatus 30 outputs a display screen for selecting a desired answer to a display apparatus (not illustrated), for example. The terminal apparatus 30 acquires, for example, a selection result of the desired answer input by the operation of the person in charge on the display screen for selecting the desired answer. Then, the terminal apparatus 30 outputs a selection result of the desired answer to the acquisition unit 11 of the document generation apparatus 10, for example.

In a case where the person in charge selects the additional document to be classified into the useful document, the terminal apparatus 30 acquires, for example, a display screen for selecting the additional document to be classified into the useful document from the output unit 15 of the document generation apparatus 10. Then, the terminal apparatus 30 outputs a display screen for selecting an additional document to be classified into a useful document to a display apparatus (not illustrated), for example. The terminal apparatus 30 acquires, for example, a selection result of the additional document to be classified into the useful document input by the operation of the person in charge on the display screen for selecting the additional document to be classified into the useful document. Then, the terminal apparatus 30 outputs the selection result of the additional document to be classified into the useful document to the acquisition unit 11 of the document generation apparatus 10, for example.

As the terminal apparatus 30, for example, a notebook personal computer or a desktop personal computer can be used. The terminal apparatus 30 is not limited to the above.

The user terminal apparatus 40 is, for example, an information processing apparatus used by a user who acquires an answer to a query in the information processing system. The user terminal apparatus 40 acquires, for example, a query input by a user's operation. Then, the user terminal apparatus 40 outputs the query input by the user to the interface unit 21 of the chat processing apparatus 20, for example. The user terminal apparatus 40 acquires, for example, an answer to the query from the interface unit 21 of the chat processing apparatus 20. Then, the user terminal apparatus 40 outputs an answer to the query to a display apparatus (not illustrated), for example.

As the user terminal apparatus 40, for example, a notebook computer, a desktop computer, a tablet computer, a smartphone, or a smart device can be used. The user terminal apparatus 40 is not limited to the above. The terminal apparatus 30 and the user terminal apparatus 40 may be the same information processing apparatus.

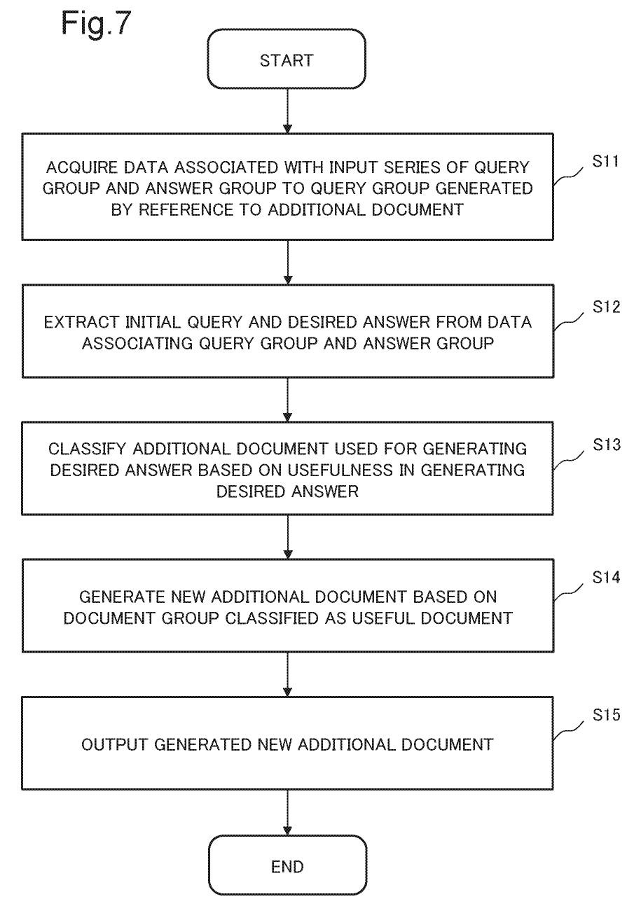

An example of the operation of the document generation apparatus 10 in the processing of generating the additional document will be described. FIG. 7 illustrates an example of an operation flow in processing of generating an additional document in the document generation apparatus 10.

The acquisition unit 11 acquires, for example, data in which a series of input query groups are associated with an answer group to the query group generated with reference to the additional document (step S11). For example, the acquisition unit 11 acquires data in which a query group and an answer group for the query group are associated with each other from the chat processing apparatus 20. The acquisition unit 11 may acquire the attribute of the user associated with the query group and the answer group for the query group.

The extraction unit 12 extracts an initial query and a desired answer that is an answer desired by the user from data in which a series of input query groups are associated with an answer group for the query group generated by referring to the additional document (step S12). The initial query is a query input initially in the query group.

When the initial query and the desired answer are extracted, the classification unit 13 classifies the additional document used to generate the desired answer based on the presence or absence of usefulness in generating the desired answer (step S13).

When the additional document is classified, the generation unit 14 generates a new additional document based on the document group classified as the useful document (step S14).

When the additional document is generated, the output unit 15 outputs, for example, the generated new additional document (step S15). The output unit 15 outputs the generated additional document to the database unit 24 of the chat processing apparatus 20, for example. The output unit 15 may output the generated new additional document in association with the attribute of the user associated with the query group used to generate the additional document and the answer group to the query group.

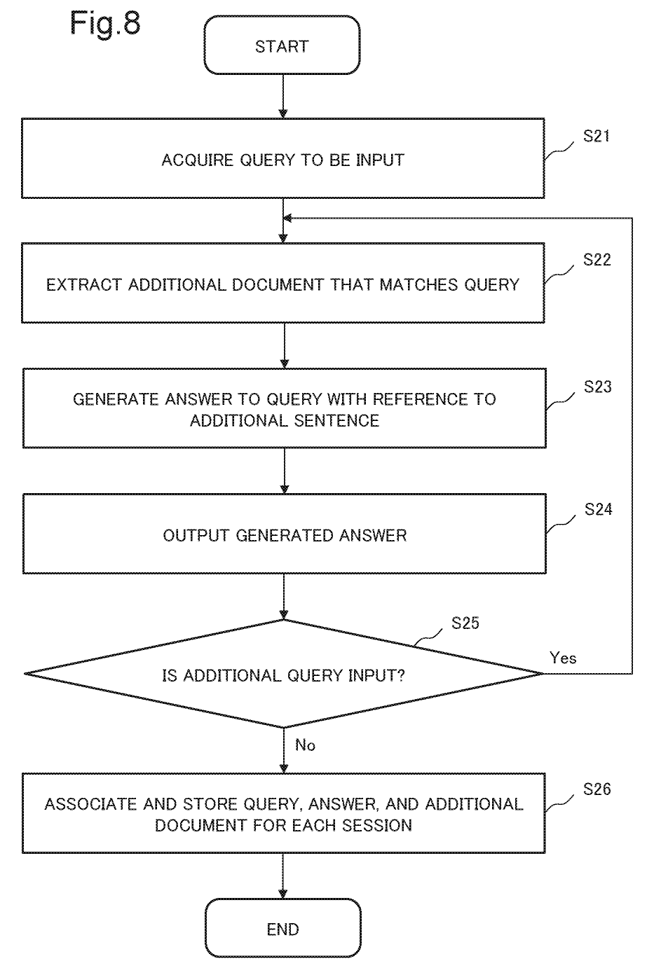

An example of an operation of the chat processing apparatus 20 in processing of generating an answer to a query will be described. FIG. 8 illustrates an example of an operation flow in processing of generating an answer to a query in the chat processing apparatus 20.

The interface unit 21 acquires, for example, an input query (step S21). The interface unit 21 acquires, for example, a query input by a user's operation from the user terminal apparatus 40.

When the query is acquired, the chat control unit 22 extracts, for example, an additional document that matches the query (step S22). For example, the chat control unit 22 extracts an additional document that matches the query from the additional documents stored in the database unit 24. The chat control unit 22 may extract an additional document that matches the query based on the attribute of the user.

When the additional document matching the query is extracted, the chat processing unit 23 generates an answer to the query with reference to the additional document, for example (step S23). The chat processing unit 23 may generate an answer to the query based on the attribute of the user.

When the answer to the query is generated, the interface unit 21 outputs the generated answer, for example (step S24). The interface unit 21 outputs the generated answer to the user terminal apparatus 40, for example.

When an additional query is input for the output answer (Yes in step S25), the processing returns to step S22, and the chat control unit 22 extracts, for example, an additional document that matches the input additional query.

In a case where the session is ended without inputting an additional query to the output answer (No in step S25), the chat control unit 22 stores the query, the answer to the query, and the additional document in association with each other for each session, for example (step S26). For example, the chat control unit 22 may further store the query, the answer to the query, and the additional document in association with the attribute of the user.

The document generation apparatus 10 extracts an initial query which is an initially input query in the query group and a desired answer which is an answer desired by the user from data in which the input series of query groups and the answer group to the query group generated by referring to the additional document are associated with each other. The document generation apparatus 10 classifies the additional documents used for generating the desired answer based on the presence or absence of usefulness in generating the desired answer. Then, the document generation apparatus 10 generates the additional document based on the document group classified as the useful document. By generating the document in this way, it is possible to easily generate a document suitable for a reference document.

By generating an answer to the query with reference to the additional document generated as described above, it is possible to suppress the number of times of processing until reaching the desired answer in a case where a query similar to the initial query is input. Therefore, by generating the additional document as described above, it is possible to suppress computer resources and power consumption necessary for generating the answer. Therefore, it is possible to efficiently obtain an answer to the query by generating the additional document as described above.

By extracting the initial query and the desired answer for each session group in which the sessions are classified into groups and generating the additional document, for example, it is possible to generate the additional document while suppressing the influence of the fluctuation in the expression of the query by the user. Therefore, a document suitable for the reference document can be generated more efficiently.

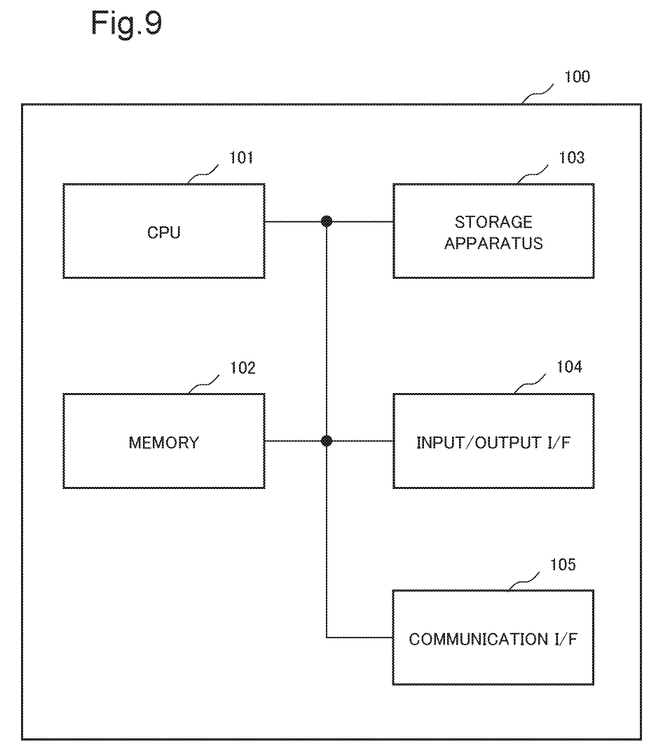

Each processing in the document generation apparatus 10 can be enabled by executing a computer program on a computer. FIG. 9 illustrates an example of a configuration of a computer 100 that executes a computer program for performing each processing in the document generation apparatus 10. The computer 100 includes a central processing unit (CPU) 101, a memory 102, a storage apparatus 103, an input/output interface (I/F) 104, and a communication I/F 105.

The CPU 101 reads and executes a computer program for performing each processing from the storage apparatus 103. The CPU 101 may be configured by a combination of a plurality of CPUs. The CPU 101 may be configured by a combination of the CPU and another type of processor. For example, the CPU 101 may be configured by a combination of a CPU and a GPU. The memory 102 includes a dynamic random access memory (DRAM) or the like, and temporarily stores a computer program executed by the CPU 101 and data being processed. The storage apparatus 103 stores a computer program executed by the CPU 101. The storage apparatus 103 includes, for example, a non-volatile semiconductor storage apparatus. As the storage apparatus 103, another storage apparatus such as a hard disk drive may be used. The input/output I/F 104 is an interface that receives an input from an operator and outputs display data and the like. The communication I/F 105 is an interface that transmits and receives data to and from the chat processing apparatus 20, the terminal apparatus 30, and the user terminal apparatus 40. The chat processing apparatus 20, the terminal apparatus 30, and the user terminal apparatus 40 may have configurations similar to those of the computer 100.

The computer program used for executing each processing can also be distributed by being stored in a computer-readable recording medium that non-transiently records data. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage apparatus may be used as a recording medium.

It has been practiced to provide answers generated using a language model in response to inquiries from users. A user acquires desired information by repeatedly making inquiries to an information processing system using a language model and acquiring answers from the information processing system. In such an information processing system, there are cases where a method is employed in which documents stored in a database that are similar to the content of a user's inquiry are extracted, and the language model generates an answer with reference to the extracted documents, thereby providing an answer that matches the user's inquiry. Such a method is called retrieval-augmented generation, for example. In the case of using the retrieval-augmented generation method, it is desirable that documents similar to the content of the inquiry are stored in the database.

The dialog management apparatus of JP 2023-176054 A generates an answer to an inquiry with reference to documents stored in a storage. The dialog management apparatus of JP 2023-176054 A generates reference documents based on the history of inquiries and answers.

In the technique described in JP 2023-176054 A, it may be difficult to generate a document suitable for a reference document.

In order to solve the above problem, an object of the present disclosure is to provide a document generation apparatus and the like that can easily generate a document suitable for a reference document.

According to the present disclosure, a document suitable for a reference document can be easily generated.

Some or all of the above example embodiments may be described as the following Supplementary Notes, but are not limited to the following.

### Supplementary Note 1

A document generation apparatus including:

an extraction unit that extracts an initial query that is an initially input query in a query group and a desired answer that is an answer requested by a user from data in which an input series of query groups is associated with an answer group for the query group generated by referring to an additional document that is a document referred to at a time of generating the answer;

a classification unit that classifies the additional document used to generate the desired answer based on presence or absence of usefulness in generation of the desired answer; and

a generation unit that generates a new additional document based on a document group classified into useful documents.

### Supplementary Note 2

The document generation apparatus according to Supplementary Note 1, wherein

the classification unit classifies each additional document used to generate the answer included in the answer group by using a language model.

### Supplementary Note 3

The document generation apparatus according to Supplementary Note 2, wherein

the classification unit classifies the additional document by using the language model at a timing based on a use state of the language model that generates the answer to the query.

### Supplementary Note 4

The document generation apparatus according to Supplementary Note 1, wherein

the generation unit generates the new additional document by summarizing additional documents included in the document group classified as the useful documents by using a language model.

### Supplementary Note 5

The document generation apparatus according to Supplementary Note 4, wherein

the classification unit classifies each referenced additional document into a group based on a stage of usefulness set in at least three stages, and

the generation unit generates the new additional document by weighting each group according to the stage of the usefulness.

### Supplementary Note 6

The document generation apparatus according to any one of Supplementary Notes 1 to 5, wherein

the extraction unit calculates, for each of a plurality of queries included in a session group, an average value of similarity to other queries included in the session group, and extracts a query having a highest average value of similarity calculated as the initial query.

### Supplementary Note 7

The document generation apparatus according to any one of Supplementary Notes 1 to 5, wherein

the extraction unit generates a query based on a plurality of queries included in a session group, and extracts the query generated as the initial query.

### Supplementary Note 8

The document generation apparatus according to Supplementary Note 7, wherein

the extraction unit calculates, for each of the plurality of queries included in the session group, an average value of similarity to other queries included in the session group, and generates a query to be extracted as the initial query based on a query in which the average value of the similarity calculated is equal to or more than a predetermined criterion.

### Supplementary Note 9

The document generation apparatus according to any one of Supplementary Notes 1 to 5, wherein

the extraction unit extracts, as the query, a query input in a predetermined order among a plurality of queries included in a query group in a session.

### Supplementary Note 10

The document generation apparatus according to any one of Supplementary Notes 1 to 9, wherein

the extraction unit extracts a most recently generated answer as the desired answer among answers included in the answer group in a session.

### Supplementary Note 11

The document generation apparatus according to any one of Supplementary Notes 1 to 10, wherein

in a case where a content of the query included in the query group changes in a middle, the extraction unit excludes the query group in which the content of the query changes in the middle and the answer group to the query group from an extraction target.

### Supplementary Note 12

The document generation apparatus according to Supplementary Note 2, wherein

the classification unit classifies the additional document by using a language model different from a language model for generating the answer to the query.

### Supplementary Note 13

The document generation apparatus according to Supplementary Note 4, wherein

the generation unit summarizes documents included in the document group classified as the useful documents by using a language model different from a language model for generating the answer to the query.

### Supplementary Note 14

The document generation apparatus according to any one of Supplementary Notes 1 to 13, further including

an output unit that outputs the new additional document generated to a database used by an information processing apparatus that controls processing of generating the answer to the query.

### Supplementary Note 15

The document generation apparatus according to Supplementary Note 14, wherein

the output unit vectorizes the new additional document generated and outputs the additional document vectorized to the database.

### Supplementary Note 16

The document generation apparatus according to any one of Supplementary Notes 1 to 15, further including

an acquisition unit that acquires data in which the query group and the answer group for the query group are associated with each other from an information processing apparatus that controls processing of generating the answer to the query.

### Supplementary Note 17

The document generation apparatus according to any one of Supplementary Notes 1 to 16, wherein

the output unit outputs a display screen for selecting an additional document to be used for generating the new additional document from the additional documents classified as the useful documents,

the acquisition unit acquires a selection result of the additional document selected on the display screen, and

the generation unit generates the new additional document by using the additional document selected in the selection result.

### Supplementary Note 18

A document generation method including:

extracting an initial query that is an initially input query in a query group and a desired answer that is an answer requested by a user from data in which an input series of query groups is associated with an answer group for the query group generated by referring to an additional document that is a document referred to at a time of generating the answer;

classifying the additional document used to generate the desired answer based on presence or absence of usefulness in generation of the desired answer; and

generating a new additional document based on a document group classified into useful documents.

### Supplementary Note 19

A non-transitory recording medium that records a program for causing a computer to execute:

processing of extracting an initial query that is an initially input query in a query group and a desired answer that is an answer requested by a user from data in which an input series of query groups is associated with an answer group for the query group generated by referring to an additional document that is a document referred to at a time of generating the answer;

processing of classifying the additional document used to generate the desired answer based on presence or absence of usefulness in generation of the desired answer; and

processing of generating a new additional document based on a document group classified into useful documents.

Some or all of the configurations described in Supplementary Notes 2 to 17 dependent on the above-described Supplementary Note 1 can also depend on Supplementary Notes 18 and 19 by the same dependency relationship as Supplementary Notes 2 to 17. Furthermore, not only the Supplementary Notes 1, 18, and 19, but also various pieces of hardware, software, and various recording means or systems for recording software can be similarly dependent on some or all of the configurations described as the Supplementary Notes without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A document generation apparatus comprising:
at least one memory storing instructions; and
at least one processor configured to access the at least one memory and execute the instructions to:
extract an initial query that is an initially input query in a query group and a desired answer that is an answer requested by a user from data in which an input series of query groups is associated with an answer group for the query group generated by referring to an additional document that is a document referred to at a time of generating the answer;
classify the additional document used to generate the desired answer based on presence or absence of usefulness in generation of the desired answer; and
generate a new additional document based on a document group classified into useful documents.

2. The document generation apparatus according to claim 1, wherein
the at least one processor is further configured to execute the instructions to:
classify each additional document used to generate the answer included in the answer group by using a language model.

3. The document generation apparatus according to claim 2, wherein
the at least one processor is further configured to execute the instructions to:
classify the additional document by using the language model at a timing based on a use state of the language model that generates the answer to the query.

4. The document generation apparatus according to claim 1, wherein
the at least one processor is further configured to execute the instructions to:
generate the new additional document by summarizing additional documents included in the document group classified as the useful documents by using a language model.

5. The document generation apparatus according to claim 4, wherein
the at least one processor is further configured to execute the instructions to:
classify each referenced additional document into a group based on a stage of usefulness set in at least three stages; and
generate the new additional document by weighting each group according to the stage of the usefulness.

6. The document generation apparatus according to claim 1, wherein
the at least one processor is further configured to execute the instructions to:
calculate, for each of a plurality of queries included in a session group, an average value of similarity to other queries included in the session group; and
extract a query having a highest average value of similarity calculated as the initial query.

7. The document generation apparatus according to claim 1, wherein
the at least one processor is further configured to execute the instructions to:
generate a query based on a plurality of queries included in a session group; and
extract the query generated as the initial query.

8. The document generation apparatus according to claim 7, wherein
the at least one processor is further configured to execute the instructions to:
calculate, for each of the plurality of queries included in the session group, an average value of similarity to other queries included in the session group; and
generate a query to be extracted as the initial query based on a query in which the average value of the similarity calculated is equal to or more than a predetermined criterion.

9. The document generation apparatus according to claim 1, wherein
the at least one processor is further configured to execute the instructions to:
extract, as the query, a query input in a predetermined order among a plurality of queries included in a query group in a session.

10. The document generation apparatus according to claim 1, wherein
the at least one processor is further configured to execute the instructions to:
extract a most recently generated answer as the desired answer among answers included in the answer group in a session.

11. The document generation apparatus according to claim 1, wherein
the at least one processor is further configured to execute the instructions to:
in a case where a content of the query included in the query group changes in a middle, exclude the query group in which the content of the query changes in the middle and the answer group to the query group from an extraction target.

12. The document generation apparatus according to claim 2, wherein
the at least one processor is further configured to execute the instructions to:
classify the additional document by using a language model different from a language model for generating the answer to the query.

13. The document generation apparatus according to claim 4, wherein
the at least one processor is further configured to execute the instructions to:
summarize documents included in the document group classified as the useful documents by using a language model different from a language model for generating the answer to the query.

14. The document generation apparatus according to claim 1, wherein
the at least one processor is further configured to execute the instructions to:
output the new additional document generated to a database used by an information processing apparatus that controls processing of generating the answer to the query.

15. The document generation apparatus according to claim 14, wherein
the at least one processor is further configured to execute the instructions to:
vectorize the new additional document; and
output the vectorized additional document to the database.

16. The document generation apparatus according to claim 1, wherein
the at least one processor is further configured to execute the instructions to:
acquire data in which the query group and the answer group for the query group are associated with each other from an information processing apparatus that controls processing of generating the answer to the query.

17. The document generation apparatus according to claim 1, wherein
the at least one processor is further configured to execute the instructions to:
output a display screen for selecting an additional document to be used for generating the new additional document from the additional documents classified as useful documents;
acquire a selection result of the additional document selected on the display screen; and
generate the new additional document by using the additional document selected in the selection result.

18. A document generation method comprising:
extracting an initial query that is an initially input query in a query group and a desired answer that is an answer requested by a user from data in which an input series of query groups is associated with an answer group for the query group generated by referring to an additional document that is a document referred to at a time of generating the answer;
classifying the additional document used to generate the desired answer based on presence or absence of usefulness in generation of the desired answer; and
generating a new additional document based on a document group classified into useful documents.

19. A non-transitory recording medium that records a program for causing a computer to execute:
processing of extracting an initial query that is an initially input query in a query group and a desired answer that is an answer requested by a user from data in which an input series of query groups is associated with an answer group for the query group generated by referring to an additional document that is a document referred to at a time of generating the answer;
processing of classifying the additional document used to generate the desired answer based on presence or absence of usefulness in generation of the desired answer; and
processing of generating a new additional document based on a document group classified into useful documents.
